(19) United States
(12) Patent Application Publication
(10) Pub. No.: US 2026/0099620 A1
(43) Pub. Date: Apr. 9, 2026

(54) System and Computer-Implemented Method for Preserving Model Confidentiality During Graph Optimizations

(71) Applicant: CentML AI Inc., Toronto (CA)

(72) Inventors: Yubo GAO, Richmond Hill (CA); Nandita VIJAYKUMAR, Toronto (CA); Maryam HAGHIFAM, Toronto (CA); Renbo TU, Toronto (CA); Christina GIANNOULA, Toronto (CA); Gennady PEKHIMENKO, Oakville (CA)

(73) Assignee: CentML AI Inc., Toronto, ON (CA)

(21) Appl. No.: 19/348,452

(22) Filed: Oct. 2, 2025

Related U.S. Application Data
(60) Provisional application No. 63/702,742, filed on Oct. 3, 2024.

(51) Int. Cl. G06F 21/62

(52) U.S. Cl. CPC G06F 21/6218

(57) ABSTRACT

A system and method are described which provide a unique obfuscation mechanism for conducting performance optimization of deep neural network (DNN) computational graphs. The method obfuscates performance optimization in three steps. First, an obfuscation step where the original computation graph is obfuscated such that an adversary cannot feasibly identify the original model, thus providing confidentiality. Second, the optimization step is carried out flexibly and independently by the optimizer party on the obfuscated computational graph, providing performance speedups. Finally, the de-obfuscation step where the original model is retrieved by the model owner in its optimized form.

### CROSS-REFERENCE TO RELATED APPLICATION(S)

This application claims priority to U.S. Provisional Patent Application No. 63/702,742 filed on Oct. 3, 2024, the contents of which are incorporated herein by reference.

### TECHNICAL FIELD

The following generally relates to computer-implemented methods for performing graph optimizations and, in particular, to preserving model confidentiality during such optimizations.

### BACKGROUND

Deep learning (DL) has emerged as a highly effective approach with a wide range of use cases. The remarkable performance achieved by DL models in domains like computer vision, natural language processing (NLP), and recommendation systems, has immensely fueled their popularity. Models for ChatGPT, stable diffusion (Rombach et al., 2021), and vision transformers (Dosovitskiy et al., 2021), all demonstrate the potential of DL models in solving complex tasks. This has led to widespread interest in the generation of new models and DL innovations for novel and more powerful capabilities in both academia and industry.

A major challenge with DL models is the significant computational overhead for training and inference. DL models may have millions to hundreds of billions of parameters (Labs, 2023), requiring significant memory and compute resources. Thus, training DL models and deploying trained models for inference can be extremely expensive and time-consuming. This issue is expected to be exacerbated in the future, as model sizes continue to grow. For example, OpenAI has reported a daily cost of $700K to run ChatGPT (Insider, 2023).

Performance optimizations using ML compilers have thus become important to efficient training and inference to reduce latency, computational expenses, and energy consumption. Recently developed optimizing compilers/tools include TVM (Chen et al., 2018), TASO (Jia et al., 2019), ONNXRuntime (developers, 2021), and Hidet (Ding et al., 2023) and is an active area of research and development. Existing tools are already proven to be highly effective in generating significant speedups and are thus widely used. For example, TVM can provide up to 3.8× speedup on model inference (Chen et al., 2018).

Model optimization and model creation/development are typically not done at the same time by the same party. Model development and optimization each typically requires different expertise and domain knowledge. For example, while model developers are good at designing neural network architectures, they often do not possess the domain skills necessary for performance optimization. This has led to the emergence of entities offering model optimization as a service such as OctoML (oct, a) and MosaicML (mos) to fill in the gap(s).

Several existing compilers (Chen et al., 2018; developers, 2021; Ding et al., 2023; NVIDIA Corporation, 2022) can be used to automatically optimize the model, potentially enabling model developers to directly produce performant implementations without a second party for optimization. However, solely relying on automatic compilers has limitations and does not eliminate the need for additional optimization expertise. First, effectively optimizing tensor computations is still challenging even when using an automatic compiler and often requires significant domain expertise and intervention. For example, correctly configuring the tensor compiler (e.g., selecting search space, using the correct floating point precision), adding previously-unsupported operators (TVM, 2023), or implementing scheduling templates for novel operators (Ding et al., 2023) requires systems expertise. Second, they have been found to be less effective at optimizing for proprietary hardware or at leveraging hardware features that are not fully exposed by hardware vendors (Zheng et al., 2020), and thus may require specialized expertise from hardware vendors about their hardware. For example, the optimizations/libraries specific to Google's TPUs in XLA and NVIDIA GPUs are closed-source and may require support from the hardware vendors when the provided tools are not effective (tfx). Third, the developers of novel optimizing tools may not provide open-source implementations or the entire toolset for automatic use due to proprietary optimizations or the need for manual intervention. For example, OctoML (oct, a) applies proprietary optimizations manually for customers (oct, b), a process which requires manual insight.

The necessity of two parties to effectively develop and optimize new DL models leads to an important and unique challenge, namely ensuring confidentiality of the DL architecture. Highly effective performance optimizations include graph-level transformations which involve optimizing the computational graph (i.e. the graph of operators). Possible transformations include techniques such as operator fusion, constant folding, and functional approximations (ort). Graph level performance optimizations typically require providing the optimizing party direct access to the entire computational graph of the model. However, the model architecture itself is valuable intellectual property to the model developers, as innovating novel DL architectures typically requires domain experts and extensive resources for neural architecture search and training. For example, NASNet (Zoph et al., 2018) is discovered through thousands of GPU days spent on neural architecture search, and a single training of GPT-3 has been found to cost $4.6M (Labs, 2023). Additionally, exposing the model architecture exacerbates the threat of adversarial attacks (Goodfellow et al., 2014) by model stealing approaches that can then be used to perform gradient-based adversarial attacks (Goodfellow et al., 2015).

### SUMMARY

DL models have revolutionized numerous domains yet optimizing them for computational efficiency remains a challenging endeavor. Development of new DL models typically involves two parties, namely the model developers and performance optimizers. The collaboration between the parties often necessitates the model developers exposing the model architecture and computational graph to the optimizers. However, this exposure is normally undesirable since the model architecture is considered valuable intellectual property, and its innovations require significant investments and expertise. During the exchange, the model is also vulnerable to adversarial attacks via model stealing.

The following describes a system also referred to interchangeably as “PROTEUS”, a mechanism that enables model optimization by an independent party while preserving the confidentiality of the model architecture. The system can obfuscate the protected model by partitioning its computational graph into subgraphs and concealing each subgraph within a large pool of generated realistic subgraphs that cannot be easily distinguished from the original. The system has been evaluated on a range of deep neural networks (DNNs), demonstrating its efficacy in preserving confidentiality without compromising performance optimization opportunities.

The system can effectively hide the model as one alternative among up to, for example, 1032 possible model architectures, and has been found to be resilient against attacks with a learning-based adversary.

The following also demonstrates that heuristic-based and manual approaches can be ineffective in identifying the protected model. The system can therefore address the challenge of model confidentiality during performance optimization.

In one aspect, there is provided a method of protecting model confidentiality during graph optimizations by other parties, comprising: performing an obfuscation by obfuscating an original computation graph to inhibit identification of the original computation graph; providing the obfuscated computation graph to an optimizer party to have one or more optimization operations applied to the obfuscated computation graph; and responsive to receiving an optimized obfuscated computation graph, performing a de-obfuscation to retrieve the original model in an optimized form.

In certain example embodiments, the obfuscation comprises graph partitioning to split the original model into a plurality of smaller subgraphs.

In certain example embodiments, the obfuscation comprises sentinel graph generation to hide the smaller subgraphs within a set of sentinel subgraphs.

In certain example embodiments, the number of smaller subgraphs makes the original model infeasible to identify while not affecting, or minimally affecting, a graph-level optimization performed by the optimizer party.

In certain example embodiments, the sentinel subgraphs are syntactically correct to avoid immediate detection.

In certain example embodiments, the sentinel subgraphs resemble real-world subgraphs.

In certain example embodiments, the optimizer party applies graph transformations to each of the provided subgraphs to achieve at least one optimization objective.

In certain example embodiments, the at least one optimization objective comprises one or more of: (i) minimizing their runtime behavior and provide performance speedups; (ii) minimizing memory footprint; (iii) ensuring hardware compatibility by replacement of some operators with others; and/or (iv) minimizing communication volume during distributed training.

In certain example embodiments, the de-obfuscation is performed by extracting and concatenating the optimized real subgraphs.

In certain example embodiments the method includes enabling parameters to be tuned prior to executing the method, the parameters to be tuned comprising a number of graph partitions generated from the original model and/or a number of sentinel subgraphs generated per protected subgraph.

In certain example embodiments, the graph partitioning comprises random node contractions repeated until fully partitioned.

In certain example embodiments, sending the obfuscated computation graph to the optimizer party exposes the obfuscated computation graph to adversaries.

In another aspect, there is provided a computer readable medium storing computer-executable instructions for performing the method and any one or more of the embodiments above in any combination.

In another aspect, there is provided a computer system comprising a processor and memory, the memory storing computer-executable instructions that, when executed by the processor, cause the computer system to performing the method and any one or more of the embodiments above in any combination.

### BRIEF DESCRIPTION OF THE DRAWINGS

Embodiments will now be described with reference to the appended drawings wherein:

FIG. 1 is an example of a computing environment in which an obfuscation system for model optimization may be deployed.

FIG. 2 is a block diagram illustrating an example configuration for a computing device that may be utilized in the computing environment.

FIG. 3 is block diagram illustrating a configuration for the system referred to herein as PROTEUS.

FIG. 4 illustrates examples of topologies sampled by the system with the left-most highlighted graphs in each row corresponding to original topologies.

FIG. 5 illustrates an example of an algorithm, referred to herein as Algorithm 1, for sampling similar topologies.

FIG. 6 illustrates an example of an algorithm, referred to herein as Algorithm 2, for generating opcode specifications.

FIGS. 7(a) and 7(b) illustrate the execution time of DL models achieved by all evaluated schemes.

FIGS. 8(a) and 8(b) compare distributions of graph statistics between real and PROTEUS-generated subgraphs.

FIG. 9 illustrates an architecture of a graph neural network (GNN) classifier.

FIG. 10 illustrates an example of an algorithm, referred to herein as Algorithm 3, for inducing orientation on GraphRNN graphs.

FIG. 11 illustrates average subgraph size versus percent performance loss with PROTEUS.

FIGS. 12(a), 12(b), 12(c), and 12(d) compare distributions of graph statistics between real and PROTEUS-generated subgraphs.

FIGS. 13(a) and 13(b) illustrate NATSBench examples.

FIGS. 14(a) and 14(b) illustrate SEResNET examples.

### DETAILED DESCRIPTION

In the following system, referred to as “PROTEUS” for ease of reference, an obfuscation mechanism is provided that aims to preserve the confidentiality of the protected model during graph optimizations. PROTEUS can effectively enable an independent party with a proprietary optimization tool such as a machine learning compiler to optimize a novel model architecture with no direct knowledge of the original model architecture. The system is largely agnostic to the optimizations themselves and can be generally used by any optimization tool.

Two important features are provided by PROTEUS. First, it can generate sentinel graphs, which are artificially generated graphs that resemble real world DL computational graphs. These sentinel graphs are provided alongside the original graph to the optimizing party such that the optimizing party cannot distinguish which graph is the protected graph. This approach alone, however, may still involve providing the optimizing party with the protected graph in its entirety.

To address this challenge, the second feature leverages graph partitioning. Graph partitioning first partitions the protected graph into smaller subgraphs. The system then generates sentinel subgraphs for each protected subgraph. The optimizing party is now provided with a bucket of sentinel subgraphs and protected subgraphs for optimization that are indistinguishable from each other. This approach requires that the adversary would have to correctly identify every protected subgraph to recover the protected model. At the same time, the optimizing party can optimize each of the subgraphs flexibly. The model owners can then trivially reconstruct the original model from the optimized subgraphs.

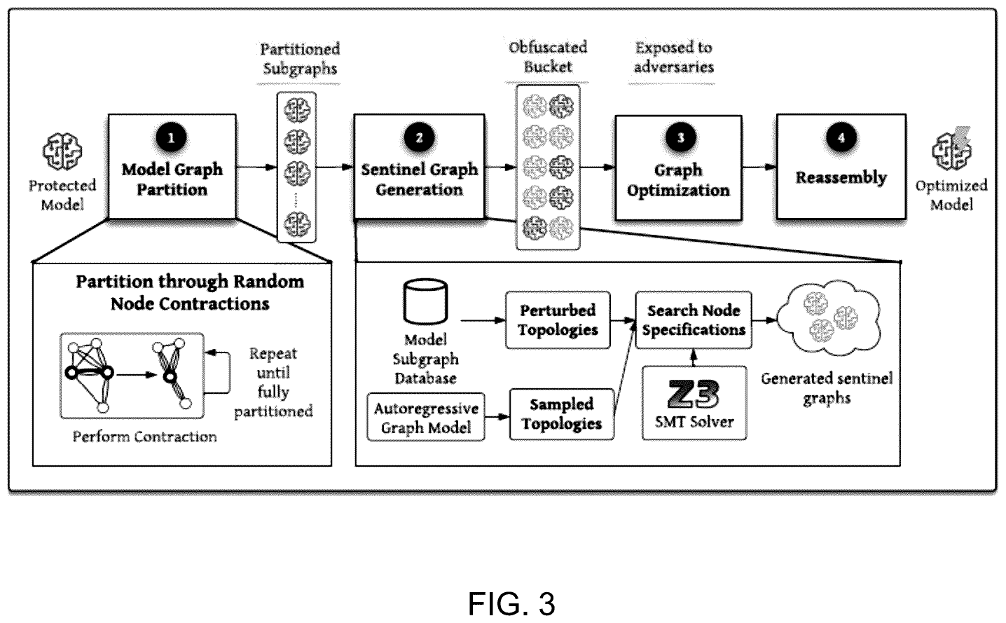

It is demonstrated herein that with sentinel generation and graph partitioning, it would be infeasibly expensive to correctly identify the original protected graph. The main elements of PROTEUS are shown in FIG. 3. At a high level, PROTEUS accepts a model to be optimized by the optimizer party. The obfuscation mechanism converts the graph that needs to be optimized (hereafter referred to as the “protected” graph) into a set of subgraphs at Stage 1 that contain both parts of the protected graph (the “protected subgraphs”) as well as artificially generated subgraphs (the “sentinel subgraphs”) at Stage 2.

The optimizer-party then performs optimizations on the collection of obfuscated subgraphs (indistinguishably includes both the original and artificial subgraphs) at Stage 3. The optimized subgraphs are returned to the model owner who can trivially assemble the optimized protected graph at Stage 4 to generate the optimized model.

There are several criteria to be met in designing the present system. First, the generated sentinel subgraphs are difficult to differentiate from the protected subgraphs, while still ensuring that no general information regarding the protected graph can be inferred. Second, it is important to perform graph partitioning such that optimization opportunities are not lost, while generating enough subgraphs to sufficiently obfuscate the protected graph.

The following discusses how PROTEUS addresses these challenges (see Section 4) and develops a mechanism that allows trading off obfuscation quality for less optimization overhead. PROTEUS is evaluated using a range of common image and language models to evaluate the effectiveness of PROTEUS's obfuscation mechanism, devising an adversarial attack using a learned classifier model to distinguish between real subgraphs and the generated sentinels. It can be demonstrated that such an attack is unable to distinguish the real protected model from a pool of, for example, 107 to 10³² potential model architectures, making recovery computationally infeasible using this method. Across all the evaluated models, PROTEUS can retain the ability of the optimizer to provide significant speedups via graph-level optimization, with what has been found to be an average speed-up within 10% of the maximum attainable by the optimizer.

The following also demonstrates PROTEUS's overall use and effectiveness using two case studies, which show that PROTEUS can remain within 1% and 10% of the speedup of the optimizer. In both cases, the method requires a learning-based adversary to evaluate more than 10²³ models in which the original model is hidden.

In summary, the following provides:
(a) a motivation for the need for a mechanism that effectively decouples model innovation and model optimization by preserving the confidentiality of the model architecture. Such a mechanism would flexibly enable model development and performance optimization to be performed by independent parties, without the optimization party having full knowledge of the confidential model architecture.
(b) PROTEUS, a mechanism to tackle this challenge of preserving confidentiality of any arbitrary DL model during performance optimization. PROTEUS partitions the protected DL model into subgraphs and hides them within sentinel graphs. PROTEUS also effectively preserves the efficacy of various graph-level optimizations performed by optimizers.
(c) a unique subgraph generation tool that is able to produce realistic artificial subgraphs to obfuscate the original subgraph. To demonstrate the robustness of the approach, a learning-based attack has been devised attempting to identify the sentinels and demonstrate that it is ultimately ineffective in recovering the protected DL model. One can also demonstrate that heuristic based, and manual approaches, are ineffective in identifying the protected model.

### 1. Computing Environment

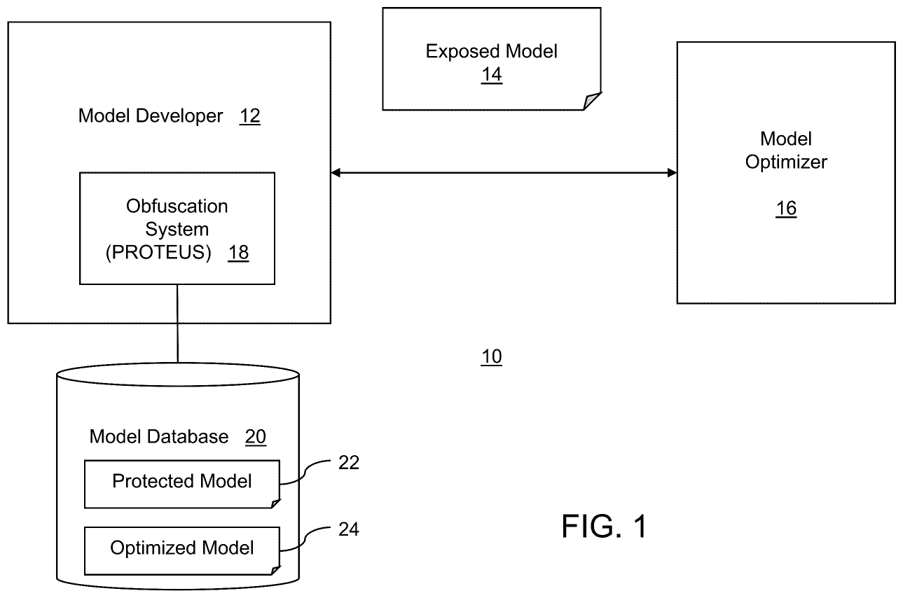

Referring now to FIG. 1, an example of a computing environment 10 is shown in which the present methods, processes and optimizations may be deployed. The computing environment 10 includes a model developer 12. The model developer 12 communicates and exchanges data with a model optimizer 16 to have a model optimized. In the course of such communications, an exposed model 14 is exchanged and may be vulnerable to adversaries. As such, the model developer 12 employs an obfuscation system 18 such as PROTEUS described herein, such that the exposed model 14 does not compromise a protected model 22. The protected model 22, which may be stored by the model developer 12 in a model database 20, is processed using the obfuscation system 18 (e.g., PROTEUS) such that the exposed model 14 can be optimized while protecting the underlying model while being able to reconstruct an optimized model 24 based on optimizations contributed by the model optimizer 16 (see also FIG. 3).

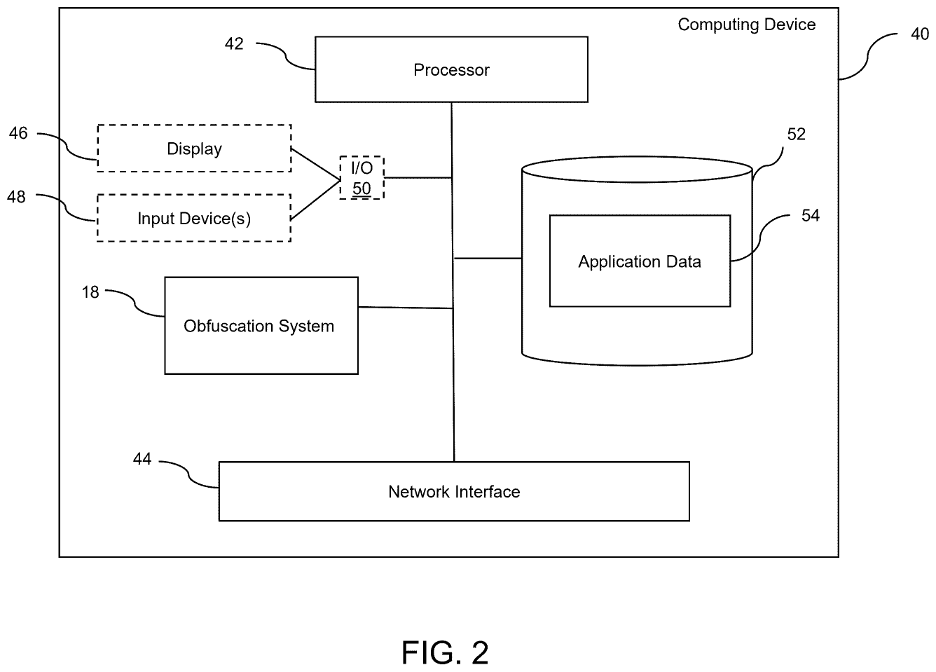

It can be appreciated that the model developer 12 and/or model optimizer 16 may be running on one or more computing devices 40 (e.g., see FIG. 2). Such computing devices 40 (or computing systems) may include, but are not limited to, a personal (e.g., desktop) computer, a server computer or other computing system that is equally or more powerful or otherwise suitably adapted to model development, compiling computer code, e.g., for use with machine learning (e.g., DL) and other artificial intelligence applications. Such computing devices 40 may also, where applicable, include a mobile phone, a laptop computer, a tablet computer, a notebook computer, a hand-held computer, a personal digital assistant, a portable navigation device, a wearable device, a gaming device, an embedded device, edge device, a virtual reality device, an augmented reality device, etc.

The model developer 12 and/or model optimizer 16 may be hosted or otherwise run on the one or more computing devices 40 or may be accessed by the computing device(s) 40 over a communication network (not shown). Such communication network(s) may include the Internet, accessed via, for example, a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet). The obfuscation system 18 may be embodied in an application, which may take the form of a mobile-type application (also referred to as an “app”), a desktop-type application, an embedded application in customized computing systems, an application programming interface (API), or an instance or page contained and provided within a web/Internet browser, to name a few.

The models 14, 22, 24 may be provided by a separate one or more computing devices 40 or computing system, by a separate entity or may be integrated with a system or application running applications for and/or by the model developer 12 and/or model optimizer 16 within the same computing device(s) 40 or computing system. As such, the configuration shown in FIG. 1 is illustrative and other computing device/system configurations are possible. For example, the computing environment 10 shown in FIG. 1 may represent a single device such as a portable electronic device or the integration/cooperation of multiple electronic devices such as a client device and server device or a client device and a remote or offsite storage or processing entity or service or multiple client or server devices working together in a compiling or other programming jobs using more than one computing device. That is, the computing environment 10 may be implemented using any one or more electronic devices including standalone devices and those connected to offsite storage and processing operations (e.g., via cloud-based computing storage and processing facilities).

FIG. 2 shows an example of one such computing device 40, e.g., from a set of one or more computing devices 40, which may be utilized by any one or more of the entities shown in FIG. 1, for example, a personal electronic device or server used to provide the model developer 12 or model optimizer 16, or other computing device 40 used to communicate with a device generating and/or providing and/or utilizing the model(s) 14, 22, 24. The computing device 40 in FIG. 2 may, additionally or alternatively, provide an example of a device on which the optimized model 24 may be deployed or accessed. Similarly, the computing device 40 in FIG. 2 may provide an example of a device on which downstream application(s)—not shown, may be deployed.

In this example, the computing device 40 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN, cellular, and/or via short-range communications protocols such as Bluetooth, WiFi, NFC, IR, etc.

The computing device(s) 40 may also include the obfuscation system 18 (or other application(s) such as a model developer suite that adopts or incorporates or communicates with an obfuscation system 18), a data store 52, and client application data 54. The data store 52 may represent a database or library or other computer-readable medium configured to store data and permit retrieval of data by the computing device 40. The data store 52 may be read-only or may permit modifications to the data. The data store 52 may also store both read-only and write accessible data in the same memory allocation. In this example, the data store 52 stores the application data 54 for the model developer 12 that is configured to be executed by the computing device 40 for a particular role or purpose. The computing device 40 may also include in the data store 52 the model database 20 (shown in FIG. 1). Alternatively, the model database 20 may be a separate component accessed by the model developer 12.

While not delineated in FIG. 2, the computing device(s) 40 include(s) at least one memory or memory device that can include a tangible and non-transitory computer-readable medium and/or volatile memory such as RAM, having stored therein computer programs, sets of instructions, code, or data to be executed by processor(s) 42. The processor(s) 42 and network interface(s) 44 are connected to each other via a data bus or other communication backbone to enable components of the computing device 40 to operate together as described herein. FIG. 2 illustrates examples of modules and applications stored in memory on the computing device 40 and executed by the processor(s) 42.

It can be appreciated that any of the modules and applications shown in FIG. 2 may be hosted externally and may be available to the computing device 40, e.g., via a network interface 44. The data store 52 in this example stores, among other things, the application data 54 that can be accessed and utilized by the obfuscation system 18 (and/or the model developer 12). The data store 52 may additionally store one or more software functions or routines in a cache or in other types of memory.

As shown in FIG. 2, the computing device(s) 40 may, optionally (e.g., when configured as a personal electronic device such as a smartphone or tablet), include a display 46 and one or more input device(s) 48 that may be utilized via an input/output (I/O) module 50. That is, such components may be omitted when the computing device 40 does not interact with a user.

While examples referred to herein may refer to a single display 46 for ease of illustration, the principles discussed herein may also be applied to multiple displays 46, e.g., to view portions of UIs rendered by or with an application on separate side-by-side screens. That is, any reference to a display 46 may include any one or more displays 46 or screens providing similar visual functions. The application receives one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user interacting with the computing environment 10, e.g., by operating the computing device 40.

### 2. Background and Related Work

### 2.1 Graph-Level Optimizations for DL Models

DL compilers (Chen et al., 2018; Jia et al., 2019; Ding et al., 2023; Sabne, 2020; Rotem et al., 2018; Cyphers et al., 2018; Ye et al., 2023) provide graph-level and operator-level optimizations for DL models to accelerate their deployment and system performance. To apply these optimizations, the DL compiler operates on the graph representation of the model, i.e., the architectural structure of the model that determines how the layers and connections are organized to process input data and generate the desired outputs. A DL model is typically expressed as a directed acyclic graph (DAG), hereafter referred to as a “computational graph”, in which the nodes represent the DL operators (e.g., convolution, pooling, activation) and the edges represent the dependencies between the nodes, i.e., the tensors given as inputs/outputs to the operators (Bengio et al., 2009).

DL compilers first apply graph-level optimizations on the computational graphs and then perform operator-level optimizations. The graph-level optimizations are rule-based transformations in that they simplify executed computations, and they are either manually designed or automatically generated using heuristics algorithms. For instance, TVM (Chen et al., 2018), TensorRT (NVIDIA Corporation, 2022), and ONNXRuntime (developers, 2021) integrate generic rule-based transformations that assist in finding and applying optimizations. ONNXRuntime supports specific graph-level optimizations, such as Identity Elimination and Reshape Fusion. TASO (Jia et al., 2019), on the other hand, automatically generates rule transformations for a given set of operators and verifies their correctness. Recently, entities (such as OctoML and MosaicML (oct, a; mos)) have emerged that provide such optimizations as a service, i.e., developing DL compilers, tools, and services that accelerate the performance of emerging DL models.

### 2.2 Data Privacy Solutions

Differential Privacy. Differential Privacy (DP) (Dwork, 2006; Dwork et al., 2014) provides privacy-preserving data analysis and learning, i.e., extracting useful statistics and information from a dataset, while protecting the identity and privacy of individuals in the dataset. Typical DP methods, e.g., Laplace mechanism (Dwork et al., 2006), inject controlled noise or randomness to the data or statistical analysis process to protect the privacy of individuals, while preserving the overall utility of the data. DP approaches (Song et al., 2013) have been proposed to protect user data that is used to train models. However, it is unclear how these approaches can protect confidentiality of DL model architecture as adding noise to it damages functional correctness of the model.

Homomorphic Encryption. Homomorphic Encryption (HE) (Gentry, 2009) allows computations to be performed on encrypted data without the need for decryption. Homomorphism-based transformations are structure preserving transformations, i.e., HE-based schemes preserve the additive and multiplicative structures of the data. Therefore, even though HE-based methods encrypt the parameters (Gilad-Bachrach et al., 2016; Hesamifard et al., 2017) of DL models (e.g., weights of matrices, tensor values), they do not encrypt operators and topology of the model. During performance optimization, HE-based methods can ensure the privacy of model parameters, but they cannot protect the model's structure.

### 2.3 Model Stealing Attacks

Model stealing includes creating a functionally equivalent model and carrying out gradient-based adversarial attacks on the model. Prior works (Oh et al., 2019; Papernot et al., 2017; Tramer et al., 2016) design algorithmic-level analysis to create functionally equivalent models. The initial phase of important adversarial attacks involves the extraction of the network architecture (topology) of the DL model: given the topology (network architecture) of a DL model is known, stealing attacks can infer the values of model parameters, hyper-parameters, and even training data (Tramer et al., 2016; Wang & Gong, 2018). There are also several model topology extraction attacks, including DeepSniffer (Hu et al., 2020) and ReverseCNN (Hua et al., 2018), which extract the model architecture by leveraging architectural hints.

### 3. The Proposed System: PROTEUS

### 3.1 Threat Model

PROTEUS aims to protect the model architecture from exposure to third parties, where the risk of model exposure is incurred when the model leaves the model owner and is:
1. intercepted by a third party in transit from the model owner to the optimizer through conventional wiretapping techniques, or
2. leaked by the optimization party to a malicious third party.

This includes the possibility where the optimizer party is also the party performing the attacks.

At the same time, implementations of the optimizing compiler remain important properties of the optimization service. Release of the optimizing compiler to the model owner incurs the risk of software piracy.

### 3.2 Goals

An objective of the system is to effectively decouple model innovation/development and performance optimization by enabling performance optimization while protecting the confidentiality of the model architecture. Ensuring privacy of the model architecture enables an independent party/service to optimize DL models. Specifically, the system aims to achieve the following goals with the proposed mechanism.
1. Model Confidentiality. Given a mechanism that obfuscates the graph to prevent the retrieval of the original architecture: an adversary with access to both the obfuscating algorithm used and the obfuscated graphs produced by the confidentiality mechanism should not be feasibly able to retrieve the initially protected graph.
2. Agnosticity and Independence of Performance Optimizations. An effective confidentiality mechanism should not constrain the optimizations that can be performed on the protected graph. This additionally enables the potential for preserving the confidentiality of the model optimizations and the compilers themselves.
3. High Performance Efficiency. Since an important goal of the optimizer is to improve the runtime performance of DL models, the confidentiality mechanism should preserve the performance benefits and ensure similar speedups as that achieved without the obfuscation mechanism.
4. Low Compilation Overhead. The confidentiality mechanism should not cause a significant compilation overhead to the optimizer party or make the optimization process more challenging. In the following disclosure, the system and its design are configured to make the overhead of confidential optimization by machine learning compiler feasible.

### 3.3 Overview

The system described herein and referred to as PROTEUS, provides a unique obfuscation mechanism for DNN computational graphs for performance optimization. PROTEUS involves optimization in three independent steps. First, the obfuscation step where the original computation graph is “obfuscated” such that an adversary cannot feasibly identify the original model, thus providing confidentiality. Second, the optimization step is carried out flexibly and independently by the optimizer party on the obfuscated computational graph, providing performance speedups. Finally, the de-obfuscation step where the original model is retrieved by the model owner in its optimized form.

### 3.4 Obfuscation: Key Ideas

Important concepts behind PROTEUS include sentinel generation and graph partitioning, each being detailed below.

### 3.4.1 Sentinel Generation

It is proposed to obfuscate the original graph by hiding the protected DL graph among a set of sentinel graphs, i.e., artificially generated realistic graphs. The idea behind this approach is that an adversary will be unable to distinguish the real graph from the sentinel models. As the set of sentinel graphs grows larger, it is more challenging to identify the protected graph. This approach enables the optimizing party to optimize the obfuscated graph by essentially optimizing all the sentinel graphs.

However, directly applying this approach can have important limitations. First, the original protected graph is still directly exposed in its entirety. Second, this approach can add overhead, sometime significantly, to the optimizing party as all the sentinel graphs need to be optimized. Generating k sentinel graphs requires both the optimizer and the adversary to carry out O(k) work, either to perform optimizations or to attempt recovery of the protected model. To address these limitations, one may first perform graph partitioning as described below.

### 3.4.2 Graph Partitioning

It has been observed that most graph-level transformations performed by tensor compilers are local graph-level substitutions performed by compilers operating on an operator and its neighboring nodes. The system leverages this observation to partition the computational graph into smaller subgraphs. These subgraphs are independently optimized and then reassembled to generate the entire optimized graph. The implications on performance speedup are evaluated in Section 5.2 and demonstrate that this only incurs small losses in performance speedups from optimizations. With graph partitioning, the sentinel graphs are now generated for subgraphs rather than the entire graph. Thus, the proposed solution can be broken down into two steps: (i) partition the protected model into smaller subgraphs and (ii) hide the protected subgraphs within a set of k sentinel subgraphs.

The use of sentinel subgraphs makes the recovery of the original model significantly more challenging for the adversary because every subgraph has to be correctly classified and identified to reconstruct the original protected graph. Thus, one can use fewer sentinel graphs while still making it infeasible to recover the original model (this has been quantitatively demonstrated in Section 4). At the same time, the model architecture in its entirety is never exposed to the optimizer.

### 3.4.3 Design Challenges

There are two major challenges in effectively obfuscating the protected graph as described above:
(i) Effective partitioning strategy: The number of subgraphs in the graph plays an important role in the ability to retain the optimization performance benefits. If the subgraphs are too small or if the partitioning eliminates optimization opportunities, the optimization schemes may be rendered less effective. At the same time, increasing the number of subgraphs obfuscates the graph more effectively and would thus require fewer sentinel graphs.
(ii) Generating sentinel graphs: It is important to generate sentinel subgraphs that are difficult to identify as artificial. Thus, they should be realistic, syntactically accurate, and resemble real world subgraphs in terms of operations, topology, etc. In other words, the sentinels should not be arbitrarily generated.

### 4. Detailed System Design

The following describes three important steps performed by PROTEUS in more detail. Section 4.1 describes the obfuscation mechanism of PROTEUS. Section 4.2 describes the optimization step to be performed by the optimizer party on the obfuscated subgraphs produced by PROTEUS. Section 4.3 describes the de-obfuscation step performed by PROTEUS to retrieve the original model in its optimized form, returning it to the model owner.

### 4.1 Obfuscation

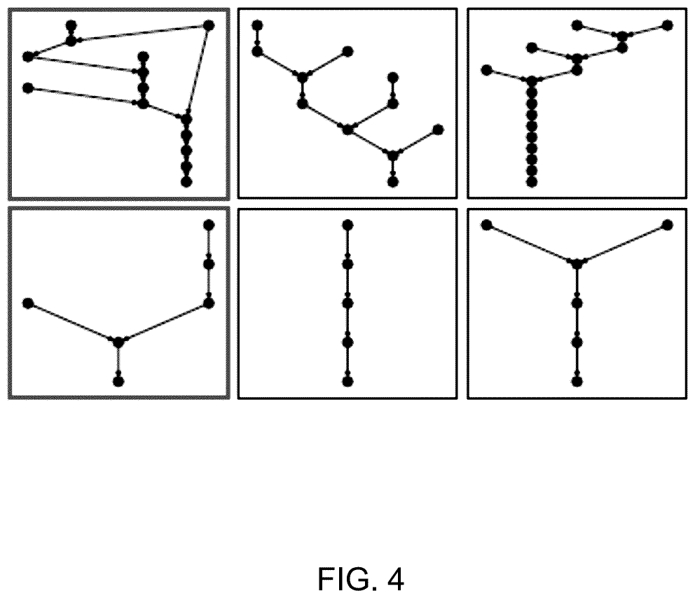

PROTEUS is an effective obfuscation mechanism that preserves confidentiality in DL models with two primary steps: (i) graph partitioning splits the protected model into smaller subgraphs, and (ii) sentinel graph generation hides the protected subgraphs within a set of k sentinel graphs. Specifically, given an arbitrary DL model, PROTEUS generates n smaller subgraphs and hides each subgraph within a set of k sentinel (artificially generated) subgraphs. This way PROTEUS hides the given protected DL model within a set of O((k+1)ⁿ) possible computational graphs. FIG. 4 illustrates examples of topologies sampled by PROTEUS, with the leftmost of each row being the original topologies.

### 4.1.1 Graph Partitioning

PROTEUS splits the protected model into n subgraphs of similar sizes. A goal is to generate many subgraphs, such that the adversary cannot feasibly identify the original model, while at the same time not affect the graph-level optimizations performed by the optimizer party. Note that with PROTEUS the optimizer applies graph-level transformations at each subgraph individually and cannot perform optimizations that span across multiple subgraphs. However, given that the system does not have any information in advance on which graph-level transformations will be performed by the optimizer, the system can employ a randomized graph partitioning algorithm to split the computational graph to n subgraphs.

A graph partitioning algorithmic scheme has been developed that can be used to leverage prior work by the Karger-Stein (K-S) algorithm (Karger, 1993). K—S is a randomized algorithm that solves the minimum-cut problem on a graph. At each step, it selects a random edge from the graph and merges the two nodes connected by the selected edge into a single node. This step is called “edge contraction”, and it is iteratively repeated until n nodes remain in the graph. When the algorithm terminates, each of the n remaining nodes represents a subgraph of the initial graph.

However, since the K-S algorithm is randomized, the resulting n subgraphs may significantly vary in size. Creating subgraphs with high disparity in their sizes brings two important issues. First, very large subgraphs may cause confidentiality issues, since they can potentially reveal many useful pieces of information to the adversary related to the initial protected graph. Second, small subgraphs might cause performance issues, since optimizers may not be able to perform very efficient graph-level transformations on small graphs. Therefore, the system can enhance the K-S algorithm to create n subgraphs of almost equal sizes. Specifically, the system can perform multiple iterations of the K-S algorithm and at each iteration evaluate the standard deviation of the sizes of the subgraphs created. Then, keep the graph partitioning scheme that minimizes the disparity in the sizes of the subgraphs, to provide a more balanced and less informative graph partitioning.

### 4.1.2 Sentinel Graph Generation

In the sentinel graph generation step, PROTEUS hides the protected subgraphs within a set of k sentinel subgraphs. The generated sentinels should be syntactically correct to avoid immediate detection. Moreover, the sentinel graphs should resemble real world ones, so that the adversary cannot differentiate between real subgraphs (extracted from the initial protected model) and the sentinel subgraphs (artificially generated using PROTEUS).

In this step, the system generates k sentinel graphs for each of the n subgraphs. One may denote the n subgraphs extracted from the original protected model with G₁, . . . , Gₙ. For each subgraph Gᵢ, generate k sentinel graphs denoted with Gᵢ⁽¹⁾, . . . , Gᵢ^{(k)}. In other words, PROTEUS creates a bucket of k+1 subgraphs, one of them is the real subgraph Gᵢ, and the remaining k subgraphs are sentinel (artificially generated) subgraphs. Therefore, the total search space for subgraphs has a size of approximately O((k+1)ⁿ).

The k generated sentinel subgraphs Gᵢ⁽¹⁾, . . . , Gᵢ^{(k)} should resemble the original real subgraph Gᵢ, such that the adversary should not be able to differentiate among them. One can categorize two types of metrics, which an adversary could use to identify the real subgraph Gᵢ:
(a) Topological Information. A subgraph can be identified by the topological connections of its nodes. Specifically, computational DL graphs are acyclic graphs that describe the dataflow of DL operators, and their nodes typically have a small number of incoming edges.
(b) Operator Information. A subgraph can be identified by the patterns of computations performed at its nodes. In a computation DL graph, nodes represent the operation applied to a tensor. Therefore, real subgraphs follow similar computational patterns: e.g., a convolution operator is commonly followed by an activation.

Based on the two types of metrics listed above, PROTEUS generates sentinel graphs in two stages. First, in the topology selection stage, the system generates the connections between the nodes in the computation graph. Second, fill in operators into the graph in the operator population stage.

Topology Selection. First generate the topologies of the sentinel graphs. The topology refers to the “shape” of the computation graph, i.e., how the nodes are connected. The topology selection process for sentinel subgraphs has two major steps: graph generation and sampling.

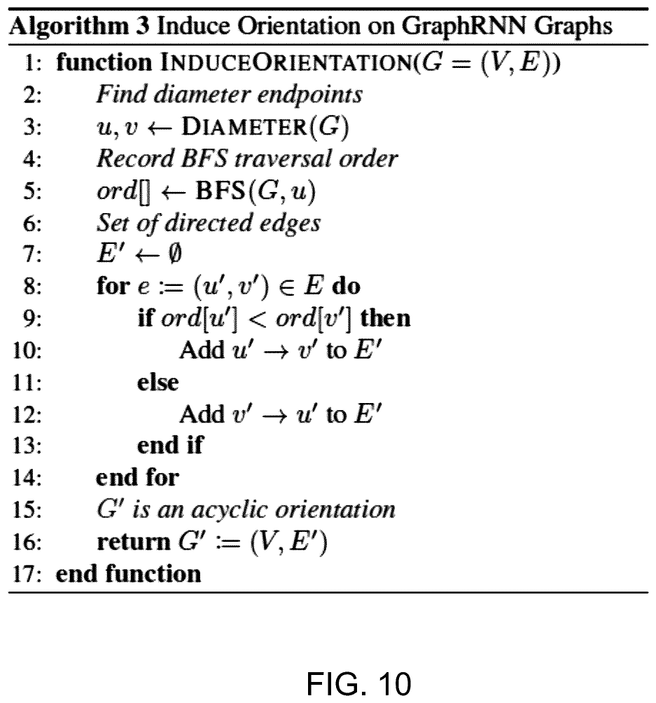

First, during the graph generation step, the system generates a pool of realistic graph topologies with GraphRNN (You et al., 2018), an autoregressive graph generation model. However, an important limitation of this GraphRNN-based approach is that it may generate undirected graphs, while DL graphs are directed. To resolve this limitation, the system can transform the undirected graphs to directed graphs using the algorithm shown in Algorithm 3 illustrated in FIG. 10, which traverses the undirected graph and assigns a direction to each edge, resulting in a DAG.

Next, the system samples sentinel topologies from the previous step that are similar to the provided real subgraph. Specifically, one may approximate the similarity measure by comparing various graph- and node-level statistics of the sentinel subgraphs with that observed of real-world subgraphs. The evaluated similarity metrics are the following: average degree, clustering coefficient, diameter, and graph size.

In Algorithm 1 shown in FIG. 5, the SAMPLETOPOLOGIES function takes as input a protected subgraph Gᵢ and generates a set of similar graph topologies that are statistically indistinguishable from Gᵢ. This is achieved by ensuring that the graph statistics form a uniform distribution around the protected subgraph Gᵢ, effectively adding random noise resulting in uncertainty. In other words, by observing the distribution of these sub-graph statistics, each subgraph would have an equal chance of being the protected subgraph. Here, the system extracts a set of GraphRNN-generated graph topologies, denoted as D, and control the range of the uniform distribution with β.

In Algorithm 1, the system establishes bounds for uniform distribution in lines 2-8, sample from this uniform distribution in lines 15-17. Notably, if one samples graphs from D uniformly at random, the resulting distribution would follow that of D rather than being uniform. To tackle this, the system can employ importance sampling which applies a weight of 1/p to each sample where p describes the density of the topology under D. This “corrects” the uneven densities under and makes the resulting samples uniform.

Operator Population. After generating graph topologies, PROTEUS assigns a DL operator at each node in the generated graph. A DL operator describes the computations that will be applied to tensor given as input (e.g., matrix multiplication, convolution, activation). The DL operators assigned to nodes need to be (i) syntactically correct, i.e., they need to have correct configurations (e.g., the number of input and output arguments, the tensor dimensions) that are consistent with specifications of DL operators, and (ii) semantically consistent, i.e., the sequence (order) of operators within the generated graph needs to resemble realistic DL operator sequences.

To ensure syntactic correctness, one can convert this problem into one of constraint satisfaction, i.e., given a set of constraints find a solution that satisfies them. In the present context, given a set of syntactic constraints for DL operators, find an assignment of DL operators to the nodes of the graph, which satisfies the given syntactic constraints. One may use Z3 (De Moura & Bjorner, 2008), an SMT solver to produce the assignment of the operators to the sentinel nodes.

Z3 takes as inputs (i) the graph topology, (ii) the list of operators, and (iii) their syntactic constraints, searches the solution space and returns a syntactically correct assignment of the operators to the nodes of the graph. For convolution and pooling, along with the operator one also may need to specify the operator's kernel shape and number of input/output channels (for 2D convolutions).

To ensure semantic consistency, the system may need to quantify the likelihood of an operator assignment. If the likelihood is high, the operator assignment is more likely to be semantically similar to real-world DL operator assignments. To compute the likelihood, the system calculates probabilities of operator sequences generated by traversing the graph.

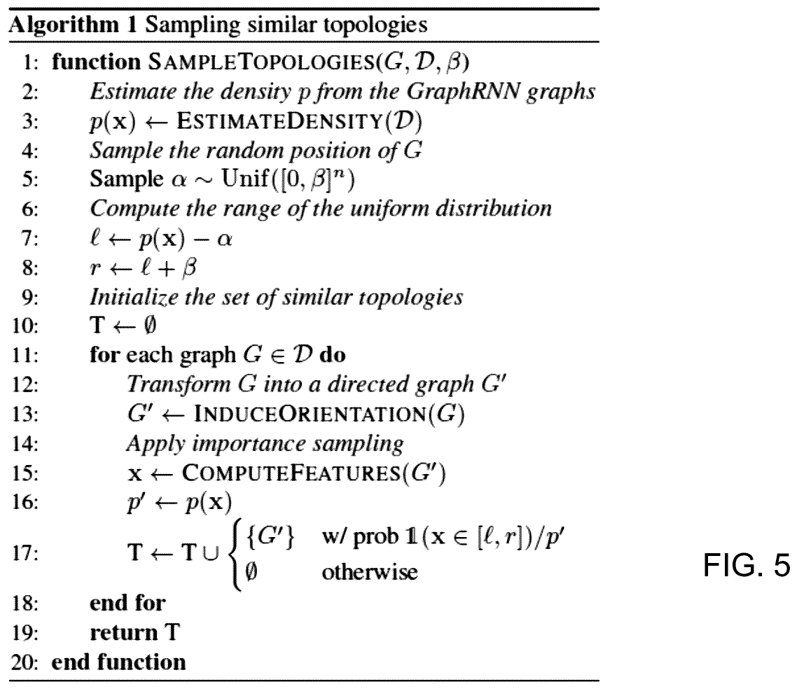

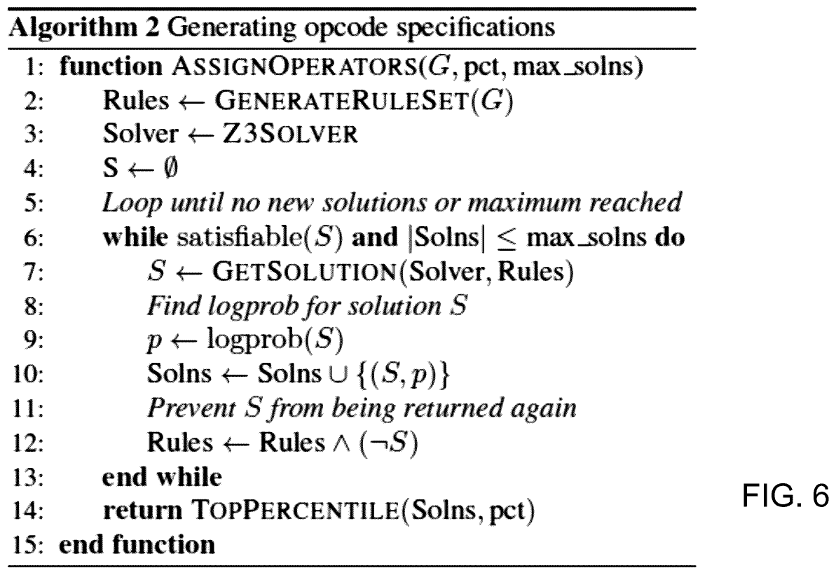

Algorithm 2 shown in FIG. 6 describes the operator assignment process. The ASSIGNOPERATORS procedure takes as input the graph topology and returns a set of operator assignments. Specifically, the system can repeatedly query the solver to find syntactically valid operator assignments. For each solution, compute its likelihood, and record it (line 8). Also, exclude the solution from being returned in a subsequent iteration. This procedure may be repeated until either the solver claims that there are no other solutions (i.e. unsatisfiable) or when the number of solutions exceeds a predefined limit (line 5). The system can return the operator assignments that are both syntactically valid and semantically likely.

Minor Modifications over Popular Models. To handle the scenarios where the original protected model is structurally very similar to commonly used popular DL models, e.g., the protected model is a ResNet-like model, PROTEUS can also generate graph topologies by modifying the topologies of popular DL models. Specifically, PROTEUS may generate new DNN-like graph topologies by adding and/or removing nodes in the existing graph topologies of popular DL models. Then, PROTEUS fills DL operators to the newly added nodes using the process described above. In these cases, the opcodes of unperturbed nodes, except for the ones that are immediately adjacent to the perturbed nodes, are preserved.

### 4.2 Optimization

After obfuscation, the set of n(k+1) obfuscated subgraphs (including the original and generated sentinels) are given to the optimizer party. The optimizer applies graph transformations to each of the provided subgraphs to minimize their runtime behavior and provide performance speedups.

The optimization step is carried independently by the optimizer party on the obfuscated subgraphs. Note that PROTEUS is largely agnostic to the optimizer, since it does not make any assumptions about the optimizer's implementation other than that it preserves functional correctness. The optimizer will then return an optimized version of each obfuscated subgraph.

### 4.3 De-Obfuscation

Upon receiving the optimized subgraphs from the optimizer, PROTEUS reconstructs the original model in its optimized form. It does so by extracting and concatenating the optimized “real” subgraphs.

Assuming that the optimization procedure performed by the optimizer is functionally correct, the optimized subgraphs are functionally equivalent to the original subgraphs (up to numerical differences). Thus, when the system reassembles the model using the optimized subgraphs, it obtains a computation that is defined by the composition of these subgraphs. If the subgraphs are functionally correct, their composition would also be functionally correct. In the present implementation, the obfuscation step generates the optimized graph by connecting the input and output edges of each adjacent subgraph. This can be done using information about sub-graph connections tracked when the graph was partitioned. Finally, the de-obfuscated graph is returned to the model owner as the optimized version of his original model.

### 4.4 Parameterization

PROTEUS provides a number of tunable parameters to the model owner outlined in Table 1 below. These parameters allow for tradeoffs between (a) the complexity of recovery by an adversary, (b) the computational overhead for the optimizer, and (c) the quality of model optimizations (in particular, the slowdown compared to optimizing without partitioning).

TABLE 1
List of Tunable Parameters Provided by Proteus

| Name | Description |
|---|---|
| n | Number of graph partitions generated from |
| | the protected graph |
| k | Number of sentinel subgraphs generated |
| | per protected subgraph |

The precise tradeoffs as a result of these parameters are tabulated in Table 2 below. These tunable parameters allow the model owner to tradeoff some potential speedups for additional and stronger obfuscation.

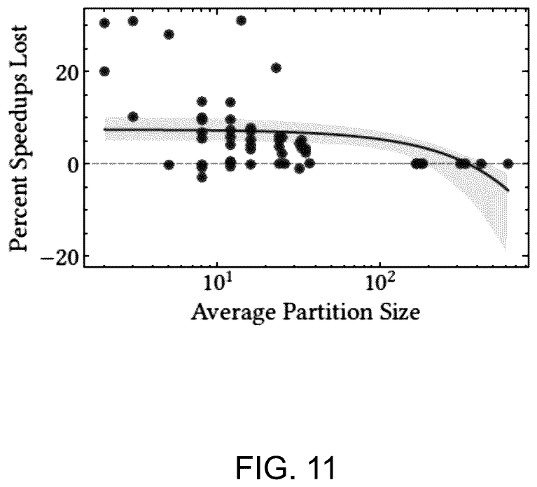

TABLE 2
Tradeoffs Resulting from Proteus's tunable parameters

| Item | Cost |
|---|---|
| Recovery cost of adversary | O((k + 1)ⁿ) |
| Computational overhead of optimizer | O(k) |
| Quality of model optimizations | See FIG. 11 |

Manual Optimization. It may be noted that while an O(k)-fold increase is acceptable for an automatic optimizer or tensor compiler. However, if each subgraph requires manual engineering efforts to optimize, this overhead could be prohibitive, and PROTEUS could be ineffective for these cases. However, it has been observed that most manual efforts are spent on development and tuning of the machine learning compiler instead of manually applying optimizations on each subgraph.

### 5. Evaluation

### 5.1 Methodology

Runtime Environment. PROTEUS may use ONNX (ONNX Contributors, 2023) for intermediate model representation, i.e., the initial DL model, its intermediate computational graph representation, and the optimized version of the given DL model are represented using the ONNX format.

To demonstrate optimizer agnosticism, one may use ONNXRuntime and Hidet for model optimizations and inference. ONNXRuntime is a performant optimizer and inference engine and Hidet (Ding et al., 2023) is a state of the art machine learning compiler.

Experiments were conducted on a a2-highgpu-1g instance on Google Cloud with 85GiB of RAM and an NVIDIA A100 GPU.

Models. One may evaluate PROTEUS using representative widely used convolutional neural networks (CNNs) that perform image classification as well as BERT-like language models (listed below in Table 3. The implementations may be obtained through the torchvision package (PyTorch, 2017) and HuggingFace Model Hub (Huggingface, 2023).

TABLE 3
Search Space Reduction for Learning-based Adversary

| | | | Random Opcodes | | | PROTEUS (Ours) | | |
|---|---|---|---|---|---|---|---|---|
| Protected Model | n | k | Specificity | min(γ) | Candidates | Specificity | min(γ) | Candidates |
| densenet | 19 | 20 | 0.000 | 1.000 | 1.32 × 10²⁵ | 0.338 | 0.757 | 8.33 × 10²¹ |
| googlenet | 11 | 20 | 0.990 | 0.356 | 7.00 | 0.346 | 0.899 | 4.30 × 10¹² |
| inception | 19 | 20 | 0.970 | 0.784 | 7.69 × 10³ | 0.229 | 0.910 | 1.23 × 10²³ |
| mnasnet | 11 | 20 | 1.000 | 0.019 | 1.00 | 0.117 | 0.944 | 9.59 × 10¹³ |
| resnet | 10 | 20 | 1.000 | 0.100 | 1.00 | 0.451 | 0.908 | 6.12 × 10¹⁰ |
| mobilenet | 11 | 20 | 0.607 | 1.000 | 2.66 × 10¹⁰ | 0.135 | 0.977 | 7.72 × 10¹³ |
| bert | 16 | 20 | 0.996 | 0.474 | 3.00 | 0.910 | 0.653 | 1.37 × 10⁷ |
| roberta | 16 | 20 | 0.990 | 0.634 | 2.00 × 10¹ | 0.862 | 0.799 | 1.54 × 10⁹ |
| xlm | 25 | 20 | 1.000 | 0.300 | 1.00 | 0.906 | 0.816 | 2.99 × 10¹¹ |

### 5.2 Performance Efficiency

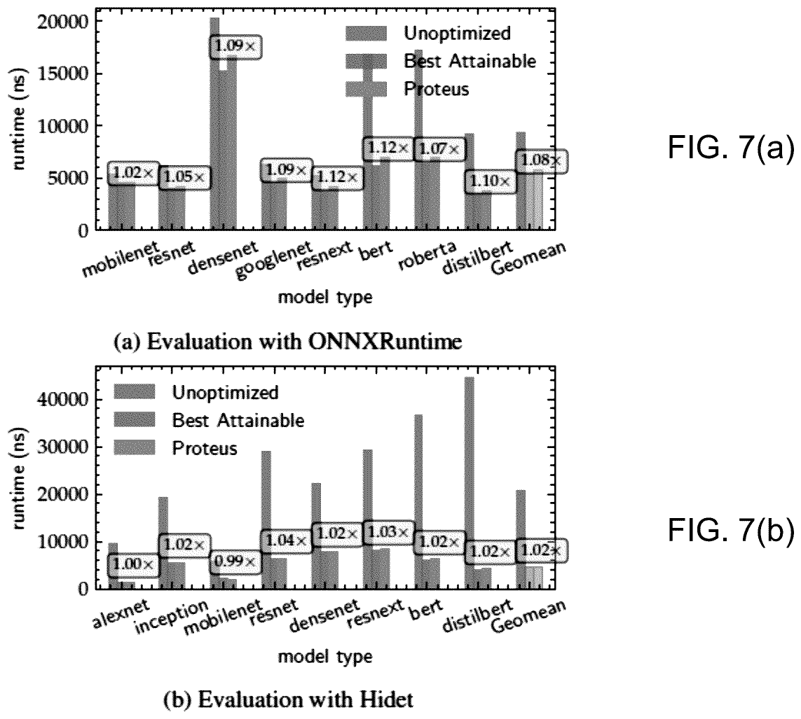

The ability of PROTEUS to retain the effectiveness of optimizations that generate performance speedups was first explored. ONNXRuntime performs a series of graph-level optimizations, from basic techniques such as constant folding to more complex operator fusion. FIGS. 7(a) and 7(b) depict the resulting runtime for different DNNs, measured using the ONNXRuntime profiling tool across 500 iterations and computing the geometric mean of a single iteration. Three different mechanisms were evaluated: (i) Unoptimized: without enabling any graph-level optimizations in the baseline graph, (ii) Best Attainable: enabling the best-performing graph level optimizations available for the initial graph, and (iii) PROTEUS: using PROTEUS to protect confidentiality of the model by partitioning into subgraphs, and then enabling the best-performing graph-level optimizations available for each subgraph.

It was observed that on average PROTEUS enables performance speedups close to the speedup of the optimizer without the confidentiality protection (within 8% of the maximum speed-up on average and at most 12%). The small loss in performance speedups is due to the partitioning approach which reduces the effectiveness of some optimization techniques. For example, if a conv operator is followed by an add operator in the original graph but the two are partitioned into different subgraphs, then fusion cannot be done between them. Performance loss due to graph partitioning is also dependent on the choice of the optimizer, i.e., the graph-level substitutions enabled by each particular optimizer. However, it may be noted that since various tensor compilers typically perform local graph transformations, similar behaviors may be seen with Hidet (Ding et al., 2023) and one may expect similar performance trends for other optimizers.

Loss of performance optimization opportunities can be correlated with the average size of the subgraphs and this is further investigated in appendix A.3. Subgraph size can be provided as a tunable parameter as larger subgraph sizes would require more sentinels and thus, higher overheads for optimization. A subgraph size of 8-16 offers a suitable balance, where performance loss is less than 10% on average and incurs only small optimization overheads and is what can be used in the remaining evaluations for PROTEUS. The optimization overhead is also correlated with the number of sentinels generated per real partition. The specifics of the tradeoff are included in appendix A.2.

### 5.3 Protection of Confidentiality

It has been demonstrated that PROTEUS generates sentinel subgraphs that are difficult to differentiate from real subgraphs by (i) evaluating graph statistics of sentinel subgraphs (Section 5.3.1), (ii) devising a learning-based adversarial attack on sentinel subgraphs (Section 5.3.2), and (iii) evaluating the feasibility of manual and expert intervention (Section 5.3.3).

### 5.3.1 Statistical Quality of Sentinel Subgraphs

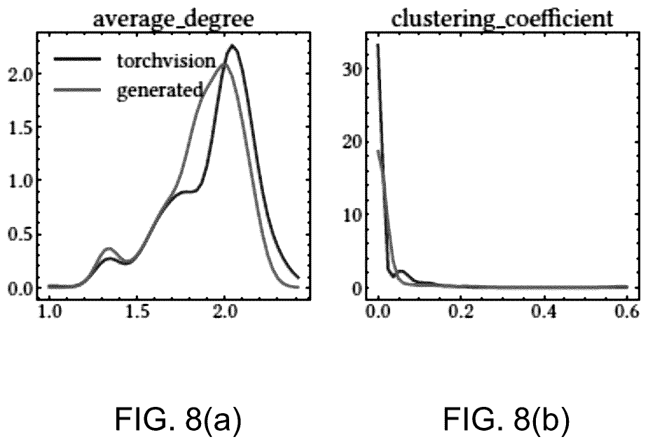

The quality of generated sentinel graphs with PROTEUS may be evaluated by comparing their distributions on various graph statistics with that of real graphs. FIGS. 8(a) and 8(b) compare the distributions between real and PROTEUS-generated graphs of their (a) average degree and (b) clustering coefficient. Appendix A.4 evaluates two additional metrics. It may be observed that sentinel subgraphs of PROTEUS have very similar distributions to that of real graphs in all evaluated metrics and would not distinguish sentinels from real graphs. One may conclude that PROTEUS is robust against mechanisms that may leverage graph heuristics or employ statistical distributions of various metrics to identify the protected graph.

It may be noted that even when using fewer metrics in Algorithm 1 (see FIG. 5), one may still observe distributional similarities in other graph metrics. This is due to GraphRNN's ability to learn complex edge dependencies by observing real topologies, then imitating it to generate realistic sentinel topologies and leads to robustness across metrics.

### 5.3.2 Learning-Based Adversarial Attack

Given the mechanism proposed in this disclosure, adversaries with the objective to recover the original protected graph fundamentally need to decide if a particular subgraph in the bucket is a PROTEUS-generated sentinel graph or part of the original protected graph.

In this section, one may put themselves into the position of one such adversary who attempts this task with a learning-based approach. Particularly, one may evaluate the effectiveness of using a GNN to perform such differentiation and investigate if the classifier helps to reduce the search space to one that compromises the model architecture.

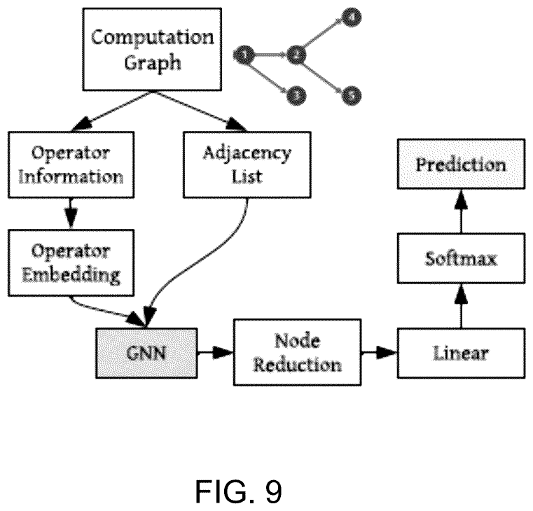

Classifier Architecture. The classifier network accepts a graph as an input and outputs its confidence that the given graph is a sentinel. The architecture of the classifier is depicted by way of example in FIG. 9, which is elaborated further in Appendix A.5 below.

Datasets. During the training and evaluation of this learning-based adversary, the GNN-based adversary may be tasked to differentiate real model subgraphs with the following:
1. Random opcodes on PROTEUS-generated topologies. Use the GraphRNN topologies with random operators.
2. Sentinel graphs from PROTEUS. Run the entire pipeline, using both GraphRNN and Z3.

In the experiments conducted, PROTEUS was tasked with protecting one model at a time. To do so, one may test the adversary on the protected model after training the classifier model on the remaining models.

Attack Mechanism. The GNN classifier outputs a confidence y∈[0, 1] of the graph being sentinel. The adversary would fix a decision boundary γ such that a graph is eliminated as fake when y≥γ. One may make a pessimistic assumption that the adversary obtains γ. It may be noted that the adversary should not erroneously eliminate any real subgraphs.

Metrics. One can measure the sensitivity (how many real subgraphs are correctly classified) and its specificity (how many fake subgraphs are correctly classified) of the adversary. Specifically, for each of the protected models test and with the choice of n, k and γ, one can measure the classifier's sensitivity (denoted a) and specificity (denoted p).

As established earlier, one should have α=1 such that all real subgraphs are correctly classified. In this case, for each of the n real subgraphs, approximately (1−β)k of its sentinel graphs are misidentified, resulting in a total number of 1+(1−β)k candidates for this particular subgraph. This results in a search space with size: [1+(1−β)k]ⁿ, within which the protected graph is hidden.

Search Space Reduction. In Table 3 above, the sizes of reduced search spaces are compared with the learning-based approach. For each model type, the specificity (p) was plotted, as well as the minimum decision threshold (γ) such that no real subgraphs are incorrectly identified. Using the cost computed above, the number of candidates in the reduced search space were also tabulated. The above is done for both the baseline (random opcode population) and PROTEUS.

It has been found that the resulting search space for differentiating PROTEUS-generated graphs from real graphs is orders of magnitude larger than that of the baseline (random opcodes). In many cases, a single candidate remains for the baseline, therefore making recovery trivial. Thus, such attacks are effective when the sentinels are not appropriately generated, as addressed by PROTEUS.

### 5.3.3 User Survey on Sentinel Graphs

To evaluate the realism of the graphs and the possibility of manually intervention by experts to identify sentinels, a survey was conducted amongst researchers in ML (details of the methodology are in Appendix A.8). The survey contains 20 computational graphs and asks the participants to classify them as either real (i.e., taken from a real popular ML model) or fake (i.e., generated by PROTEUS). Out of 13 participants, the average accuracy is 52%, similar to that of random guesses. The survey can be accessed here and contains randomly chosen sample sentinel graphs that demonstrate the infeasibility of distinguishing sentinels simply by visual inspection from experts.

### 6. Case Studies

Two archetypal scenarios of graph-level model optimization are presented: in the first case, the proposed model is unique and dissimilar to existing ones; and in the second, the proposed model largely resembles one that is widely used. In appendix A.7, the study also evaluates the potential of GNN adversary presented in Section 5.3.2 in these case studies and present some visual examples of misclassified graphs.

### 6.1 Optimizing NAS Model

In the first scenario, the user optimizes a more “exotic” model that is very dissimilar to existing ones. For this purpose, one may sample a model from NATSBench's (Dong et al., 2021) search space. Optimizing this model with ONNXRuntime results in a slowdown of 2.15×. This is potentially due to some optimizations that are typically beneficial but turned out harmful for this particular exotic model. When this model is optimized with PROTEUS, a similar outcome (slowdown of 2.164×) can be observed. Furthermore, the search space size is 1.18×10²¹ for the GNN adversary.

### 6.2 Optimizing a ResNet-Like Model

In the second case study, the user attempts to optimize a model that resembles ResNet, SEResNet (Hu et al., 2019). The main difference lies in the addition of squeeze excitation blocks. In the ideal case of optimizing the model directly, the maximum attainable speedup is 1.663×. With PROTEUS, one can obtain a speedup of 1.494×, representing a ≈10% penalty. Furthermore, the search space size is 1.22×10⁸⁷ for the GNN adversary.

### 7. Conclusion

In this disclosure, a question of confidential compiler graph-level optimization for deep learning models is introduced and motivated. The proposed solution, PROTEUS, obfuscates the original model within realistic artificially generated computational graphs. PROTEUS can be largely agnostic to the optimization approach and is thus generally applicable. The incurred computational overhead may be considered trivial when using modern graph-level compilers.

PROTEUS's robustness against learning-based, heuristic-based, and manual approaches, that are unable to distinguish the sentinel and protected subgraphs have been demonstrated.

### APPENDIX A

### A.1 GraphRNN Induce Orientation

The function INDUCEORIENTATION (see FIG. 10) takes as input a graph G=(V,E) and returns a directed graph G′=(V,E′), replacing undirected edges of E with directed edges in E′. In line 2, first find the endpoints u, v E V of the diameter of the graph. Next, one can traverse G with BFS beginning from the endpoint node u (line 3), and record the order in which nodes are accessed in the graph traversal, which is stored in the array ord. Using ord, determine the orientation of each edge e∈E: orient the edges to point from the node with smaller ord to the one with greater ord. The directed edges are collected in E′, and the resulting acyclic directed graph G′=(V,E′) is returned.

### A.2 Parameterization

PROTEUS provides a number of tunable parameters to the model owner outlined in Table 1 above. These parameters allow for tradeoffs between (a) the complexity of recovery by an adversary, (b) the computational overhead for the optimizer, and (c) the quality of model optimizations (in particular, the slowdown compared to optimizing without partitioning).

The precise tradeoffs as a result of these parameters are tabulated in Table 2 above. These tunable parameters allow the model owner to tradeoff some potential speedups for additional and stronger obfuscation.

For the DNNs in the evaluation, optimizing the original model takes 6 s on average and up to 22 s with Hidet on an AMD EPYC 7282 CPU. If Proteus produces 50 sentinel graphs, thus optimizing both the original as well as sentinels would take 5 minutes on average and up to 18 minutes. PROTEUS results in a k-fold increase in compilation time, where k is the number of sentinels generated per partition, and as demonstrated above this cost is not prohibitive.

A.3 Subgraph Size vs. Slowdown

As suggested in section 5.2, many optimizations would be ineligible due to the small graph size (as optimizations cannot be applied across partitions). PROTEUS provides the number of subgraphs n as a tunable parameter to the user. In this section the correlation between subgraph size and slowdown compared to optimal (where the entire graph is optimized as a whole) is evaluated.

FIG. 11 evaluates the trade-off between the size of the subgraphs and potential performance loss across all the evaluated DL models. One may normalize performance loss as percentage over Best Attainable. Each point in the figure represents the inference latency for a model and one of the three setups above. It is observed that with very small subgraph sizes, PROTEUS incurs small performance losses. However, when the average subgraph size becomes large, PROTEUS achieves negligible performance losses.

### A.4 Graph Metrics of Generated Sentinels

Consider D to be the distribution of generated sentinel graphs, and let G be the real subgraph. The distribution of various graph characteristics for D∪{G} should not be significantly different from the original distribution D.

Otherwise, an adversary could distinguish the protected subgraph by learning the characteristics of the generated sentinels. For this, the sentinel subgraphs should be realistic and similar to real world subgraphs.

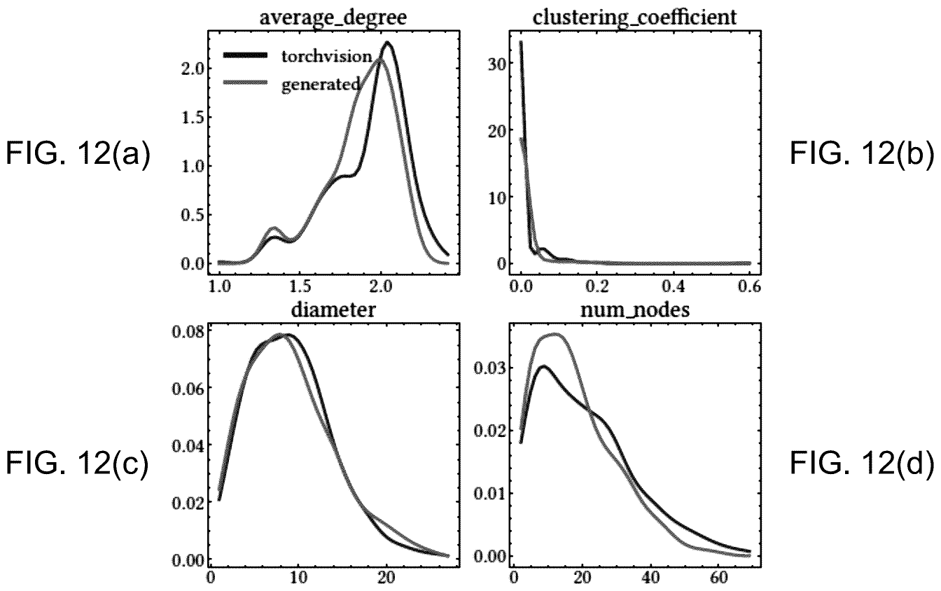

FIGS. 12(a) to 12(d) present the distributions of (i) the real-world subgraphs extracted from torchvision models, and (ii) the sentinel (artificially) generated subgraphs produced by PROTEUS (Algorithm 1—see FIG. 5) using different graph statistics. One may use the set of graph statistics explained in Section 4.1.2, i.e., (a) average degree, (b) clustering coefficient, (c) graph diameter and (d) number of nodes.

The X axis represents the value for the particular metric and the Y axis represents the probability density. From the figures it may be observed that very little statistical difference between the two groups. Thus, it may be concluded that the sentinel subgraphs produced using the present approach are highly realistic, resembling real world subgraphs and it would be very difficult for a potential adversary making use of these graph statistics from to differentiate real graphs from the sentinels.

### A.5 Classifier Architecture

The classification network performs graph convolutions using SAGEConv (Hamilton et al., 2018) with the objective to learn features of the local neighborhood for each node in the graph. After that, aggregation is done across the nodes with mean reduction. This step essentially generates a hidden representation for the entire graph from the node representations after the GNN. The final classification is generated with linear layers acting on the reduced graph representation.

### A.6 Adversary Cost

The adversary attempts to shrink its search space by eliminating fake graphs from the obfuscated bucket so as to narrow down on the “possibly-real” graphs. It is noted that it should not classify any real subgraphs as being sentinels, as that would eliminate the actual protected graph from its search space. Therefore, it should fix some decision boundary γ, such that a graph is eliminated as fake when the classifier's confidence exceeds γ.

The value of γ defines how conservative the adversary is in eliminating potential sentinel graphs. Decreasing γ would reduce the number of “potentially-real” graphs, resulting in a smaller search space. However, by doing so the adversary also risks incorrectly eliminating a real subgraph. In practice, it would be difficult for an actual adversary to obtain the minimum value of γ without a priori knowledge of the protected graphs, since it would not have access to the confidences of the classifier on them. However, one may wish to establish an approximate lower bound for the cost of attack by assuming the pessimistic case where the adversary obtains the optimal (i.e. lowest possible) γ through some (e.g., statistical) means.

### A.7 Case Studies

For both cases, the standard configuration may be used, setting n=[N/8](where N is the total size of the original model, such that subgraphs on average have 8 nodes) and k=50.

A.7.1 Optimizing a NAS model

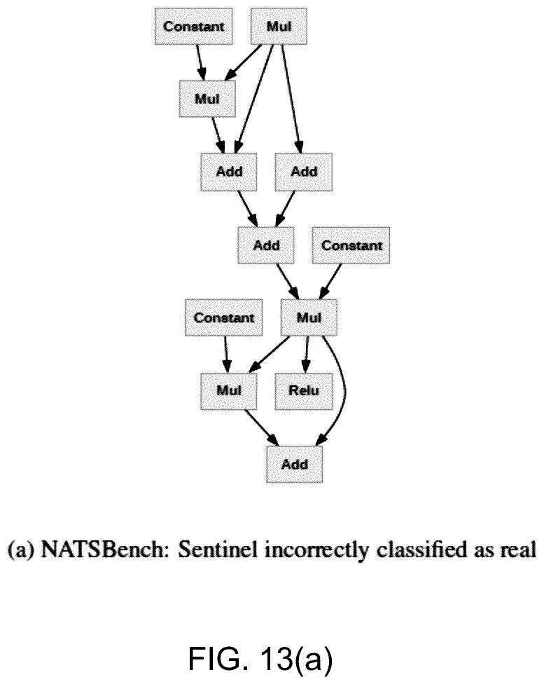

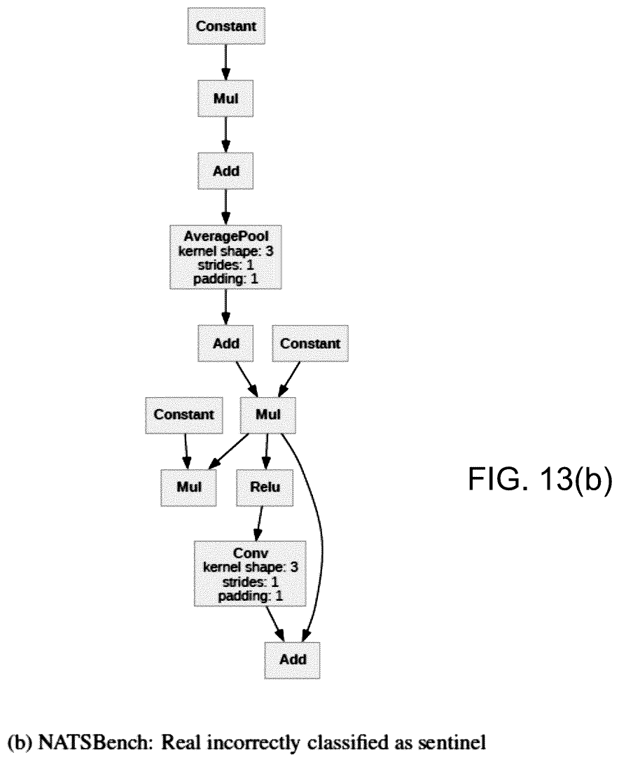

In addition to faithfully recreating the effects of optimizing the model directly, the obfuscation mechanism also is effective in protecting the model against recovery. In this case, the GNN classified many real graphs as being fake (in many cases concluding which with a 99% certainty). Shown in FIGS. 13(a) and 13(b) are two examples incorrectly classified subgraphs from NATSBench.

Setting γ accordingly resulted in a sensitivity of 84.9%. With n=24 and k=50, this resulted in [50(1−0.849)]²⁴≈1.18×10²¹ candidates which the adversary would need to evaluate.

### A.7.2 Optimizing a ResNet-Like Model

Due to the similarity between SEResNet with ResNet, one may expect most of the real subgraphs to be classified correctly, but some fake graphs are classified as real. Setting γ=0.79, the sensitivity of the classifier is 44%. Using n=83 and k=20, the number of potential candidates is [20(1−0.44)]⁸³≈1.22×10¹⁷.

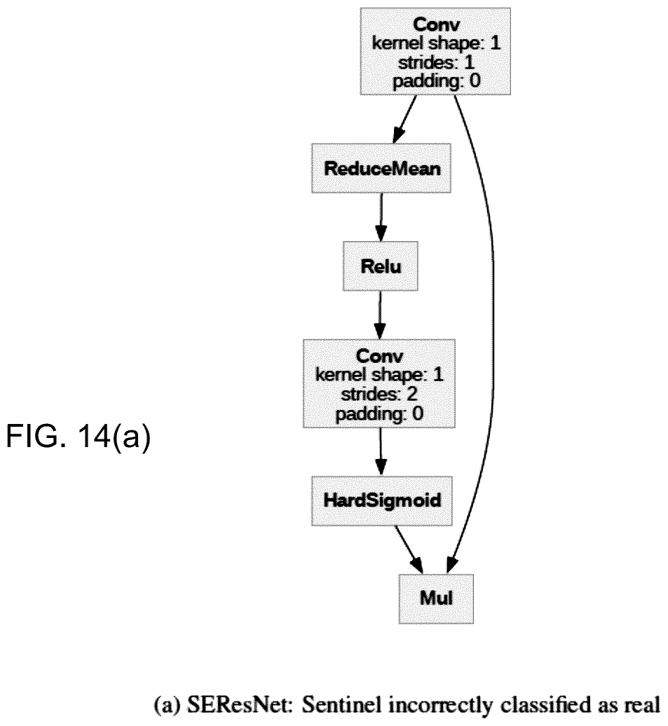

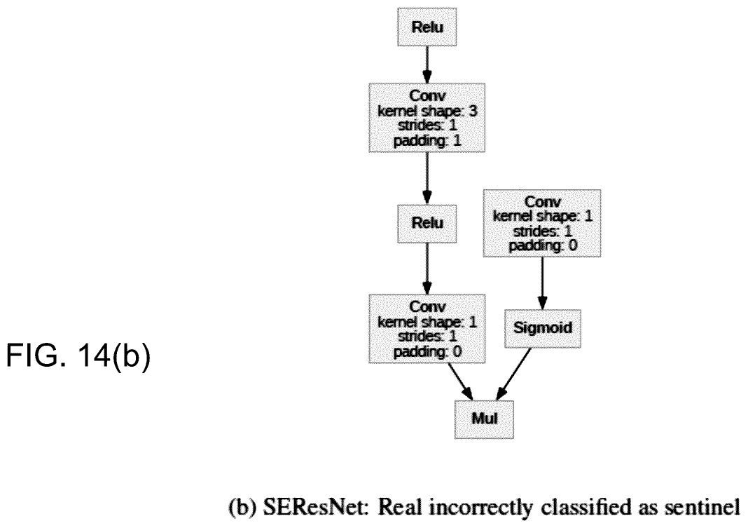

A few examples of incorrectly classified SEResNet examples are show in FIGS. 14(a) and 14(b).

### A.8 Survey Study

The possibility of manual identification by experts to eliminate sentinels produced by PROTEUS was evaluated. To do so, an internal survey was conducted amongst ML researchers from the authors' primary institute. The survey contains 20 subgraphs consisting of 10 real subgraphs extracted models taken from torchvision and HuggingFace, and also another 10 subgraphs, which are PROTEUS-created sentinels using the aforementioned real models.

To generate graphs for the survey, PROTEUS is configured to partition reals graphs into subgraphs of sizes 8-16 nodes. Next, use PROTEUS to generate fake graphs from each of the real partitions. This way one can create a pool of real subgraphs and another pool of PROTEUS sentinel subgraphs. The twenty graphs are selected from the aforementioned pools at random with some small graphs filtered out.

For each of the twenty graphs, ask the participants to select between two options: (i) real and (ii) fake subgraph. Out of thirteen participants, the average accuracy was found to be 52%, which demonstrates that the average guess of a participant is the same effective as guessing randomly. It may be concluded that the sentinel graph generation is robust against identification using expert knowledge and manual intervention through visual inspection. The survey can be accessed here and provides visual examples of sentinel and real graphs, demonstrating the realism of the sentinel graphs.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

### REFERENCES

Mosaicml—brave new cloud. https://www.mosaicml.com/. Accessed: 2022-12-01.
Model optimization and automated deployment by the octoml platform. https://octoml.ai/, a. Accessed: 2022-12-01.
How 4× speedup on generative video model (film) created huge cost savings for wombo. OctoML, b. URL https://octoml.ai/blog/how-4×-speedup-on-generative-video-model-film-created-huge-cost-savings-for-wombo/. Accessed on May 21, 2023.
Graph optimizations. ONNX Runtime website. URL https://onnxruntime.ai/docs/performance/model-optimizations/graph-optimizations.html. Accessed on May 21, 2023.
Issues·tensorflow/tensorflow·github. GitHub Issues. URL https://github.com/tensorflow/tensorflow/issues?q=is %3Aissue+is %3Aopen+XLA. Accessed on May 21, 2023.
Bengio, Y. et al. Learning deep architectures for ai. Foundations and trendsR in Machine Learning, 2(1):1-127, 2009.
Chen, T., Moreau, T., Jiang, Z., Zheng, L., Yan, E., Cowan, M., Shen, H., Wang, L., Hu, Y., Ceze, L., Guestrin, C., and Krishnamurthy, A. Tvm: An automated end-to-end optimizing compiler for deep learning, 2018. URL https://arxiv.org/abs/1802.04799.
Cyphers, S., Bansal, A. K., Bhiwandiwalla, A., Bobba, J., Brookhart, M., Chakraborty, A., Constable, W., Convey, C., Cook, L., Kanawi, O., et al. Intel ngraph: An intermediate representation, compiler, and executor for deep learning. arXiv preprint arXiv:1801.08058, 2018.
De Moura, L. and Bjorner, N. Z3: An efficient smt solver. In Proceedings of the Theory and Practice of Software, 14th International Conference on Tools and Algorithms for the Construction and Analysis of Systems, TACAS'08/ETAPS'08, pp. 337-340, Berlin, Heidelberg, 2008. Springer-Verlag. ISBN 3540787992.
developers, O. R. Onnx runtime. https://onnxruntime.ai/, 2021. Version: x.y.z.
Ding, Y., Yu, C. H., Zheng, B., Liu, Y., Wang, Y., and Pekhimenko, G. Hidet: Task-mapping programming paradigm for deep learning tensor programs. In Proceedings of the 28th ACM International Conference on Architectural Support for Programming Languages and Operating Systems, Volume 2, pp. 370-384, 2023.
Dong, X., Liu, L., Musial, K., and Gabrys, B. NATSbench: Benchmarking NAS algorithms for architecture topology and size. IEEE Transactions on Pattern Analysis and Machine Intelligence, pp. 1-1, 2021. doi: 10.1109/tpami.2021.3054824. URL https://doi.org/10.1109%2Ftpami.2021.3054824.
Dosovitskiy, A., Beyer, L., Kolesnikov, A., Weissenborn, D., Zhai, X., Unterthiner, T., Dehghani, M., Minderer, M., Heigold, G., Gelly, S., Uszkoreit, J., and Houlsby, N. An image is worth 16×16 words: Transformers for image recognition at scale, 2021.
Dwork, C. Differential privacy. In Automata, Languages and Programming: 33rd International Colloquium, ICALP 2006, Venice, Italy, Jul. 10-14, 2006, Proceedings, Part II 33, pp. 1-12. Springer, 2006.
Dwork, C., McSherry, F., Nissim, K., and Smith, A. Calibrating noise to sensitivity in private data analysis. In Halevi, S. and Rabin, T. (eds.), Theory of Cryptography, pp. 265-284, Berlin, Heidelberg, 2006. Springer Berlin Heidelberg. ISBN 978-3-540-32732-5.
Dwork, C., Roth, A., et al. The algorithmic foundations of differential privacy. Foundations and TrendsR in Theoretical Computer Science, 9(3-4):211-407, 2014.
Gentry, C. Fully homomorphic encryption using ideal lattices. In Proceedings of the forty-first annual ACM symposium on Theory of computing, pp. 169-178, 2009.
Gilad-Bachrach, R., Dowlin, N., Laine, K., Lauter, K., Naehrig, M., and Wernsing, J. Cryptonets: Applying neural networks to encrypted data with high throughput and accuracy. In International conference on machine learning, pp. 201-210. PMLR, 2016.
Goodfellow, I. J., Shlens, J., and Szegedy, C. Explaining and harnessing adversarial examples, 2014. URL https://arxiv.org/abs/1412.6572.
Goodfellow, I. J., Shlens, J., and Szegedy, C. Explaining and harnessing adversarial examples, 2015.
Hamilton, W. L., Ying, R., and Leskovec, J. Inductive representation learning on large graphs, 2018.
Hesamifard, E., Takabi, H., and Ghasemi, M. Cryptodl: Deep neural networks over encrypted data. arXiv preprint arXiv:1711.05189, 2017.
Hu, J., Shen, L., Albanie, S., Sun, G., and Wu, E. Squeeze and excitation networks, 2019.
Hu, X., Liang, L., Li, S., Deng, L., Zuo, P., Ji, Y., Xie, X., Ding, Y., Liu, C., Sherwood, T., et al. Deepsniffer: A dnn model extraction framework based on learning architectural hints. In Proceedings of the Twenty-Fifth International Conference on Architectural Support for Programming Languages and Operating Systems, pp. 385-399, 2020.
Hua, W., Zhang, Z., and Suh, G. E. Reverse engineering convolutional neural networks through side-channel information leaks. In Proceedings of the 55th Annual Design Automation Conference, pp. 1-6, 2018.
Huggingface. Hugging face—the ai community building the future. https://huggingface.co, 2023.
Insider, B. Chatgpt could cost over $700,000 per day to operate. microsoft is reportedly trying to make it cheaper. https://www.businessinsider.com/how-much-chatgpt-costs-openai-to-run-estimate-report-2023-4, 2023.
Jia, Z., Padon, O., Thomas, J., Warszawski, T., Zaharia, M., and Aiken, A. Taso: Optimizing deep learning computation with automatic generation of graph substitutions. In Proceedings of the 27th ACM Symposium on Operating Systems Principles, SOSP '19, pp. 47-62, New York, NY, USA, 2019. Association for Computing Machinery. ISBN 9781450368735. doi: 10.1145/3341301.3359630. URL https://doi.org/10.1145/3341301.3359630.
Karger, D. R. Global min-cuts in rnc, and other ramifications of a simple min-out algorithm. In ACM-SIAM Symposium on Discrete Algorithms, 1993.
Labs, L. Demystifying gpt-3. https://lambdalabs.com/blog/demystifying-gpt-3, 2023. Blog post.
NVIDIA Corporation. TensorRT: Programmable Inference Accelerator, 2022. https://developer.nvidia.com/tensorrt.
Oh, S. J., Schiele, B., and Fritz, M. Towards reverse engineering black-box neural networks. Explainable AI: Interpreting, Explaining and Visualizing Deep Learning, pp. 121-144, 2019.
ONNX Contributors. ONNX: Open Neural Network Exchange. https://onnx.ai/, 2023. Accessed: May 21, 2023.
Papernot, N., McDaniel, P., Goodfellow, I., Jha, S., Celik, Z. B., and Swami, A. Practical black-box attacks against machine learning. In Proceedings of the 2017 ACM on Asia conference on computer and communications security, pp. 506-519, 2017.
PyTorch. torchvision: datasets, transforms and models specific to computer vision. https://pytorch.org/vision/, 2017.
Rombach, R., Blattmann, A., Lorenz, D., Esser, P., and Ommer, B. High-resolution image synthesis with latent diffusion models, 2021.
Rotem, N., Fix, J., Abdulrasool, S., Catron, G., Deng, S., Dzhabarov, R., Gibson, N., Hegeman, J., Lele, M., Levenstein, R., et al. Glow: Graph lowering compiler techniques for neural networks. arXiv preprint arXiv:1805.00907, 2018.
Sabne, A. Xla: Compiling machine learning for peak performance. 2020.
Song, S., Chaudhuri, K., and Sarwate, A. D. Stochastic gradient descent with differentially private updates. In 2013 IEEE Global Conference on Signal and Information Processing, pp. 245-248, 2013. doi: 10.1109/GlobalSIP.2013.6736861.
Tramèr, F., Zhang, F., Juels, A., Reiter, M. K., and Ristenpart, T. Stealing machine learning models via prediction apis. In USENIX security symposium, volume 16, pp. 601-618, 2016.
TVM. Adding an operator to relay—tvm 0.13.dev0documentation. https://tvm.apache.org/docs/dev/how to/relay add op.html, 2023.
Wang, B. and Gong, N. Z. Stealing hyperparameters in machine learning. In 2018 IEEE symposium on security and privacy (SP), pp. 36-52. IEEE, 2018.
Ye, Z., Lai, R., Shao, J., Chen, T., and Ceze, L. Sparsetir: Composable abstractions for sparse compilation in deep learning. In Proceedings of the 28th ACM International Conference on Architectural Support for Programming Languages and Operating Systems, Volume 3, pp. 660-678, 2023.
You, J., Ying, R., Ren, X., Hamilton, W. L., and Leskovec, J. Graphrnn: Generating realistic graphs with deep autoregressive models, 2018.
Zheng, L., Jia, C., Sun, M., Wu, Z., Yu, C. H., Haj-Ali, A., Wang, Y., Yang, J., Zhuo, D., Sen, K., et al. Ansor: Generating high-performance tensor programs for deep learning. In Proceedings of the 14th USENIX Conference on Operating Systems Design and Implementation, pp. 863-879, 2020.
Zoph, B., Vasudevan, V., Shlens, J., and Le, Q. V. Learning transferable architectures for scalable image recognition, 2018.

1. A computer-implemented method of protecting model confidentiality during graph optimizations by other parties, comprising:
performing an obfuscation by obfuscating an original computation graph to inhibit identification of the original computation graph;
providing the obfuscated computation graph to an optimizer party to have one or more optimization operations applied to the obfuscated computation graph; and
responsive to receiving an optimized obfuscated computation graph, performing a de-obfuscation to retrieve the original model in an optimized form.

2. The method of claim 1, wherein the obfuscation comprises:
graph partitioning to split the original model into a plurality of smaller subgraphs.

3. The method of claim 1, wherein the obfuscation comprises:
sentinel graph generation to hide the smaller subgraphs within a set of sentinel subgraphs.

4. The method of claim 2, wherein the number of smaller subgraphs makes the original model infeasible to identify while not affecting, or minimally affecting, a graph-level optimization performed by the optimizer party.

5. The method of claim 2, wherein the sentinel subgraphs are syntactically correct to avoid immediate detection.

6. The method of claim 2, wherein the sentinel subgraphs resemble real-world subgraphs.

7. The method of claim 1, wherein the optimizer party applies graph transformations to each of the provided subgraphs to achieve at least one optimization objective.

8. The method of claim 7, wherein the at least one optimization objective comprises one or more of:
(i) minimizing runtime behavior and providing performance speedups;
(ii) minimizing memory footprint;
(iii) ensuring hardware compatibility by replacement of some operators with others; and/or
(iv) minimizing communication volume during distributed training.

9. The method of claim 1, wherein the de-obfuscation is performed by extracting and concatenating the optimized real subgraphs.

10. The method of claim 2, further comprising:
enabling parameters to be tuned prior to executing the method, the parameters to be tuned comprising a number of graph partitions generated from the original model and/or a number of sentinel subgraphs generated per protected subgraph.

11. The method of claim 2, wherein the graph partitioning comprises random node contractions repeated until fully partitioned.

12. The method of claim 1, wherein sending the obfuscated computation graph to the optimizer party exposes the obfuscated computation graph to adversaries.

13. A computer readable medium storing computer-executable instructions for protecting model confidentiality during graph optimizations by other parties, the method comprising:
performing an obfuscation by obfuscating an original computation graph to inhibit identification of the original computation graph;
providing the obfuscated computation graph to an optimizer party to have one or more optimization operations applied to the obfuscated computation graph; and
responsive to receiving an optimized obfuscated computation graph, performing a de-obfuscation to retrieve the original model in an optimized form.

14. A computer system comprising:
a processor; and
a memory, the memory storing computer-executable instructions that, when executed by the processor, cause the computer system to protect model confidentiality during graph optimizations by other parties, by executing instructions comprising:
performing an obfuscation by obfuscating an original computation graph to inhibit identification of the original computation graph;
providing the obfuscated computation graph to an optimizer party to have one or more optimization operations applied to the obfuscated computation graph; and
responsive to receiving an optimized obfuscated computation graph, performing a de-obfuscation to retrieve the original model in an optimized form.

15. The system of claim 14, wherein the obfuscation comprises:
graph partitioning to split the original model into a plurality of smaller subgraphs.

16. The system of claim 14, wherein the obfuscation comprises:
sentinel graph generation to hide the smaller subgraphs within a set of sentinel subgraphs.

17. The system of claim 15, wherein the number of smaller subgraphs makes the original model infeasible to identify while not affecting, or minimally affecting, a graph-level optimization performed by the optimizer party.

18. The system of claim 15, wherein the sentinel subgraphs are syntactically correct to avoid immediate detection.

19. The system of claim 15, wherein the sentinel subgraphs resemble real-world subgraphs.

20. The system of claim 14, wherein the optimizer party applies graph transformations to each of the provided subgraphs to achieve at least one optimization objective.
